(19) United States
(12) Patent Application Publication
(10) Pub. No.: US 2003/0024603 A1
(43) Pub. Date: Feb. 6, 2003

(54) Apparatus for supporting a material processing device

(76) Inventor: Joseph G. Pica, Springfield, NJ (US)

Correspondence Address: LERNER, DAVID, LITTENBERG,, KRUMHOLZ & MENTLIK, 600 SOUTH AVENUE WEST, WESTFIELD, NJ, 07090, US

(21) Appl. No.: 09/901,201

(22) Filed: Jul. 9, 2001

(51) Int. Cl. B25H 1/00

(52) U.S. Cl. 144/286.5

(57) ABSTRACT

An apparatus for suspending a material processing device (such as, for example, a chop saw) between first and second support structures (such as, for example, first and second saw horses). The support structures respectively have first and second support surfaces (such as, for example, the tops of the saw horses) arranged within a plane and defining a space therebetween across which a material to be operated on by the device (such as, for example, wood in the form of a beam) is supportable on the first and second support surfaces. The material processing device has a material support surface (such as, for example, a bed of the chop saw). In an embodiment, the apparatus includes a device support surface upon which the material processing device is supportable with the material support surface in the plane, and at least one support member securing the device support surface to the first and second support structures so that the device support surface is suspended within the space and preferably adjustable below the plane.

### BACKGROUND OF THE INVENTION

Material processing devices such as, for example, powered and non-powered tools, are well known as being useful for processing materials according to the requirements of various construction projects. Certain power tools such as, for example, table saws, power drills, and chop saws similar to the chop saw 10 illustrated in FIG. 1 are typically characterized by an operational surface such as, for example, a bed 20 on which a workpiece of material is supported and/or guided during the processing. Further, such power tools are also typically characterized by an operative member such as, for example, a drill or blade 30 that works on the workpiece during the processing. In many cases, the bed 20 serves as a support surface and/or a guide surface in order to optimize the work performed by the blade 30.

For example, a carpenter desiring to make an incision in or through a block of wood typically will place the block on the bed of a chop saw, and hold the block steady with one hand while operating the chop saw with the other hand to bring the blade of the chop saw to bear against the block until the block is cut as desired.

Or, for example, a carpenter desiring to cut a beam of wood typically will place the beam across the bed of a chop saw, and move the beam on the bed with one or both hands as the table saw operates, to bring the beam to bear against the blade until the beam is cut as desired.

However, when the material to be processed is in the form of an elongated workpiece such as, for example, a beam, a problem arises in that while the target portion of the workpiece (the portion to be processed) fits on the bed of the power tool, a large majority of the workpiece will typically extend beyond the edges of the bed. Unless the extensions are supported, the weight of the extensions will pull on the target portion and/or make the target portion difficult to control. Further, the weight of the extensions prevents the carpenter from holding the workpiece level on the bed.

Solutions to these problems include providing a power tool support structure that supports a power tool on a central support with a device support surface and which has side supports to support the extensions of the workpiece when the target portion of the workpiece is supported on the bed of the power tool. The height of each side support surface on which an extension is supported can be adjusted to bring the level of the side support surfaces coplanar with the bed surface. In some of these support structures, the height of the device support surface can also be adjusted, to bring the level of the bed surface coplanar with the side support surfaces.

These support structures are not without their limitations. First, power tools from different manufacturers have different dimensions, a relevant one for this discussion being the distance from the bottom surface of the power tool (the surface that contacts the device support surface when the power tool is supported on the central support) to the bed surface (the surface on which the target portion of the workpiece is supported). Each support structure is manufactured to ensure that when the power tool for which the support is designed is placed on the device support surface, the bed surface is within the range of height adjustability of the side support surfaces, and/or the height adjustability of the device support surface can be adjusted to bring the bed surface coplanar with the side support surfaces. Consequently, a power tool for which the support structure is not designed can be supported on the central support, but the height of the bed surface may be too high or too low (even if the height of the device support surface can be adjusted), such that the height of the side support surfaces cannot be adjusted to be coplanar with the bed surface. Therefore, there is a need for an apparatus that effectively supports a plurality of power tools, each having a different bottom surface to bed surface dimension, such as power tools from different manufacturers.

Second, even when the heights of the side support surfaces and the device support surface can be adjusted so that the bed surface and the sides support surfaces are coplanar, the adjustment mechanisms include moving and mechanically cooperating parts that place stresses on one another. Therefore, these adjustment mechanisms are unreliable and prone to failure. Therefore, there is a need for a power tool support apparatus that reduces the number of moving parts in the adjustment mechanisms and the complexity of their interaction.

Third, the side supports are spaced at a limited distance from the central support, and therefore can only effectively support extensions of the workpiece up to a certain length. If the extensions are longer, the problems caused by the weight of the extensions are not eliminated. Even though additional supports (such as, for example, saw horses) can be placed beyond the side supports for supporting very long extensions, it is rare that saw horses available at a given construction site will be the same height as the side supports. Any disparity between the heights can cause the processing of the material to be compromised by the inability to optimally position the workpiece. For example, the beam would be angled, and therefore the cuts made by the blade of the power tool could be off-specification. Further, even if the heights of the side support surfaces can be adjusted to be coplanar with the saw horse support surfaces, the height of the device support surface must also be adjusted. In addition, at many construction sites, not all of the saw horses are the same height, and there may not be enough saw horses of the proper height to even make such an arrangement useful. Nor would it be convenient to transport a number of saw horses of the right height to each location where the power tool will be used. Therefore, there is a need for a power tool support apparatus that can support very long extensions of the workpiece.

### SUMMARY OF THE INVENTION

The invention overcomes the limitations discussed above by providing an apparatus for supporting a material processing device. In an embodiment, the invention provides an apparatus for suspending a material processing device (such as, for example, the chop saw of FIG. 1) between first and second support structures (such as, for example, first and second saw horses). The support structures respectively have first and second support surfaces (such as, for example, the tops of the saw horses) arranged within a plane and defining a space therebetween across which a material to be operated on by the device (such as, for example, wood in the form of a beam) is supportable on the first and second support surfaces. The material processing device has a material support surface (such as, for example, the bed of the chop saw of FIG. 1).

The apparatus in this embodiment includes a device support surface upon which the material processing device is supportable with the material support surface in the plane. The apparatus in this embodiment further includes at least one support member securing the device support surface to the first and second support structures so that the device support surface is suspended within the space and below the plane.

In an aspect, the support member includes first and second support members, the first support member having a contact surface that can rest in the plane on the first support surface and the second support member having a contact surface that can rest in the plane on the second support surface.

In another aspect, the device support surface is adjustable below the plane. Preferably in this aspect, support member comprises a groove and the device support surface is provided by a device support member having a tongue that can engage the groove to secure the device support member to the support member.

Also preferably in this aspect, the tongue is operable to engage the groove to secure the device support member in each of a plurality of alternate orientations in which the device support member can be secured by engagement of the groove by the tongue, wherein each orientation locates the device support surface at a respective one of a plurality of alternate locations.

In some embodiments in this aspect, the device support member has at least one other tongue operable to engage the groove to secure the device support member in each of a plurality of additional alternate orientations in which the device support member can be secured by engagement of the groove by the other tongue, wherein each additional alternate orientation locates the device support surface at a respective one of a plurality of additional alternate locations.

Also preferably in this aspect, the device support member has top and bottom surfaces, and a side separating the top and bottom surfaces and from which the tongue protrudes, the side being thicker than the tongue.

Also preferably in this aspect, an offset distance from the tongue to the top surface and an offset distance from the tongue to the bottom surface are not equal.

Also preferably in this aspect, the groove has a bottom surface and the tongue has top and bottom surfaces, and when the tongue engages the groove such that the bottom surface of the tongue is in contact with the bottom surface of the groove, the top surface of the device support member serves as the device support surface and the device support surface is at a first distance from the plane, and when the tongue engages the groove such that the top surface of the tongue is in contact with the bottom surface of the groove, the bottom surface of the device support member serves as the device support surface and the device support surface is at a second distance from the plane, the first and second distances being of different lengths.

In another embodiment, the invention provides an apparatus for locating a surface (such as, for example, a material processing device support surface) at each of a plurality of alternate locations relative to a reference plane (such as a plane in which the material to be processed can be positioned). The apparatus in this embodiment includes a member (such as, for example, a device support member) having a surface (such as, for example, a device support surface) and having a tongue operable to engage a groove (such as, for example, a groove on a vertical support member) to secure the member in each of a plurality of alternate orientations in which the member can be secured by engagement of the groove by the tongue, wherein each orientation locates the surface at a respective one of the alternate locations.

In one aspect, the member has top and bottom surfaces, and a side from which the tongue protrudes, the side being thicker than the tongue.

Preferably in this aspect, an offset distance from the tongue to the top surface and an offset distance from the tongue to the bottom surface are not equal.

Also preferably in this aspect, the member has at least one other tongue operable to engage the groove to secure the member in each of a plurality of additional alternate orientations in which the member can be secured by engagement of the groove by the other tongue, wherein each additional alternate orientation locates the surface at a respective one of a plurality of additional alternate locations.

Also preferably in this aspect, the groove has a bottom surface and the tongue has top and bottom surfaces, and when the tongue engages the groove such that the bottom surface of the tongue is in contact with the bottom surface of the groove, the top surface of the member serves as the surface and the surface is at a first distance from the plane, and when the tongue engages the groove such that the top surface of the tongue is in contact with the bottom surface of the groove, the bottom surface of the member serves as the surface and the surface is at a second distance from the plane, the first and second distances being of different lengths.

In another embodiment, the invention provides a planar substrate (such as, for example, a device support member) that includes top and bottom surfaces, two parallel sides separating the top and bottom surfaces, and two parallel guide members (such as, for example, tongues), one extending along each side, each guide member being thinner than the sides. An offset distance from the top surface to either guide member and an offset distance from the bottom surface to either guide member are not equal.

In another embodiment, the invention provides a planar substrate (such as, for example, a device support member) that includes top and bottom surfaces, each shaped as an equilateral polygon with its number of sides being a multiple of four, and at least two sets. Each set includes two parallel sides separating the top and bottom substrate surfaces, and two parallel guide members, one guide member extending along each side, each guide member having top and bottom surfaces respectively coplanar with the top and bottom surfaces of the other guide. Each set has associated therewith two distances, one being a distance from either top guide surface to the bottom substrate surface, the other being a distance from either bottom guide surface to the top substrate surface. None of the distances in any of the sets is equal to another distance in any of the sets.

### BRIEF DESCRIPTION OF THE DRAWINGS

FIG. 1 shows a perspective view of a material processing device.

FIG. 2 shows a perspective view of an apparatus of the invention supporting the material processing device of FIG. 1.

FIG. 3 shows a disassembled perspective view of the apparatus of FIG. 2.

FIG. 4 shows a partial close-up perspective view of a device support member of the apparatus of FIG. 2.

### DETAILED DESCRIPTION

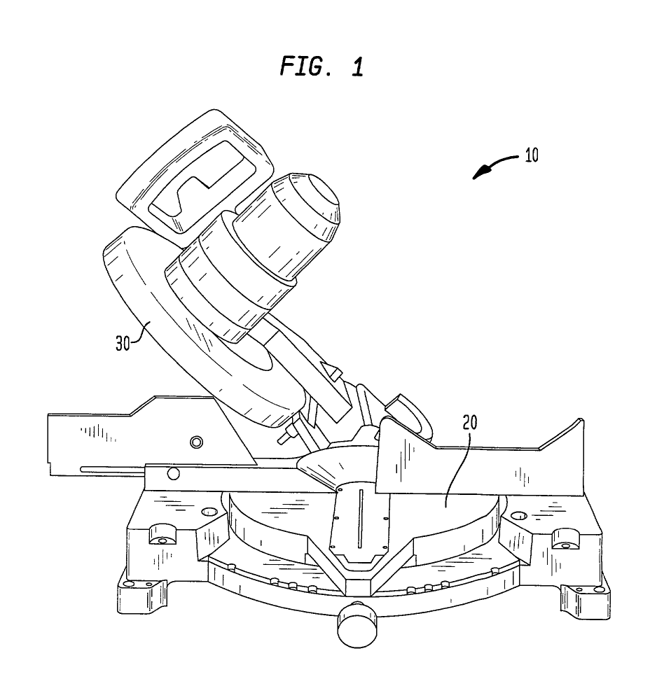

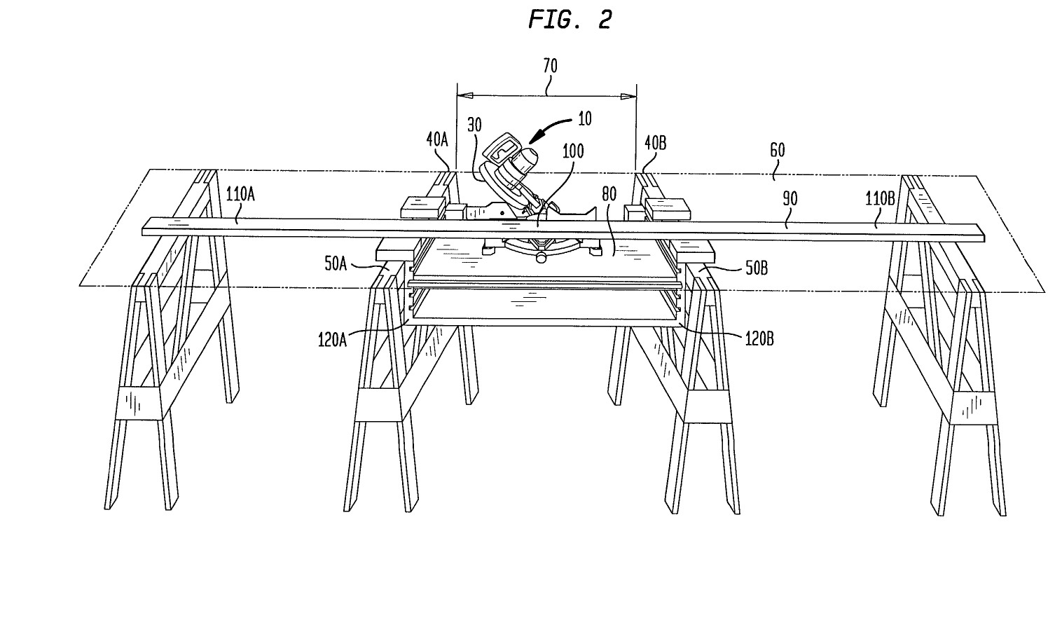

Referring to FIG. 2, a preferred embodiment of an apparatus of the invention is shown suspending a material processing device 10 (such as, for example, the chop saw 10 of FIG. 1) between first and second support structures 40A,40B. The first and second support structures 40A,40B respectively have first and second support surfaces 50A,50B arranged within a plane 60 and defining a space 70 therebetween across which a material to be operated on by the device 10 is supportable on the first and second support surfaces 50A,50B. The material processing device 10 has a material support surface (hidden in this figure) (such as, for example, the bed 20 of the chop saw 10 of FIG. 1) and an operative member 30 (such as, for example, the blade 30 of the chop saw 10 of FIG. 1).

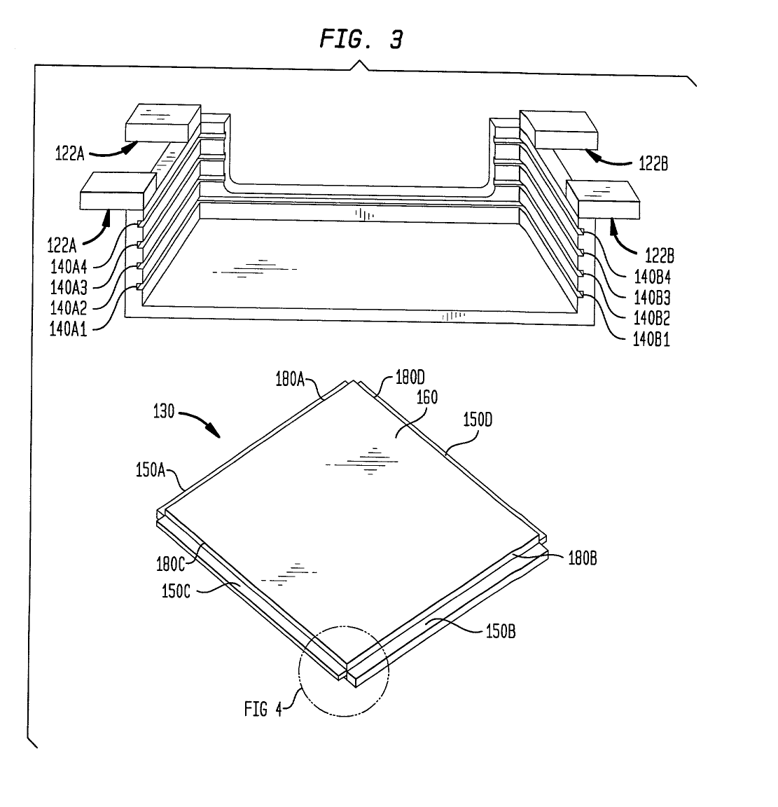

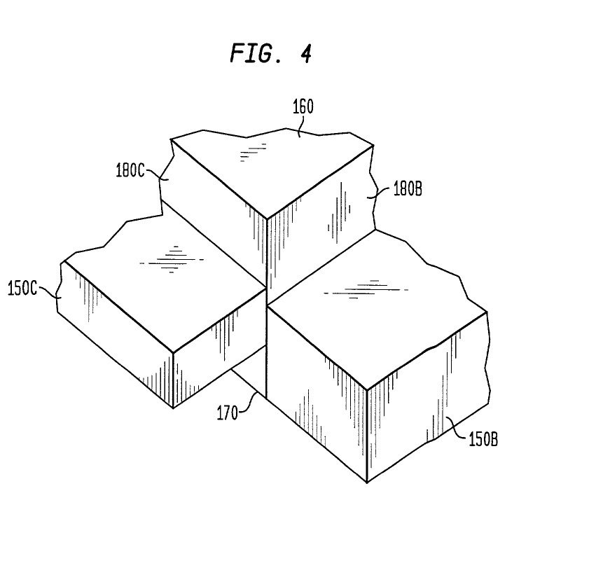

Referring now also to FIG. 3, the apparatus of FIG. 2 is shown in disassembled perspective view. Referring now also to FIG. 4, the device support member 130 of the apparatus of FIG. 2 is shown in partial close-up perspective view.

The apparatus includes a device support surface 80 and at least one support member 120A,120B securing the device support surface 80 to the first and second support structures 40A,40B so that the device support surface 80 is suspended within the space 70 and below the plane 60. In this embodiment, the device support surface 80 is provided by the device support member 130 and the apparatus includes first and second vertical support members 120A,120B extending upwardly from the device support member 130 and secured to the first and second support structures 40A,40B. More specifically with regard to the securing, the first support member 120A has a downwardly facing contact surface 122A that can rest within the plane 60 on the first support surface 50A, and the second support member 120B has a downwardly facing contact surface 122B that can rest within the plane 60 on the second support surface 50B. When the apparatus is disposed such that the contact surfaces 122A,122B rest on the support surfaces 50A,50B, the weight of the apparatus under gravity secures the support members 120A,120B to the support structures 40A,40B.

It should be understood that in some embodiments, the support member 120A,120B securing the device support surface 80 to the support structures 40A,40B can have a protrusion (e.g., a lip) protruding from a downwardly facing contact surface 122A,122B to prevent lateral movement of the support member 120A,120B relative to the support structure to 40A,40B to which it is served.

It should also be understood that in some embodiments, the support member 120A,120B securing the device support surface 80 to the support structures 40A,40B can be rigid or flexible, and can be attached to the support structures 40A,40B by additional and/or alternative securing systems. For example, clamps, clips, vices, ropes, cables, wires, magnets and other attachment devices can be used, even when the support member 120A,120B does not have a downwardly facing contact surface 122A,122B to contact the first and second support surfaces 50A,50B.

The material processing device 10 can be supported on the device support surface 80 as shown, such that the material support surface 20 of the device 10 is coplanar with the plane 60. The material to be operated on by the device 10 can be in the form of a workpiece 90 (such as, for example, an elongated beam 90) and is supportable in the plane 60, with a target portion 100 of the workpiece 90 supported on the material support surface 20 of the device 10, and extensions 110A,110B of the workpiece 90 supported on the first and second support surfaces 50A,50B. Once the workpiece 90 is so supported, the operative member 30 of the device 10 can be brought to bear on the target portion 100 of the workpiece 90, to effect the desired material processing.

The distance from the device support surface 80 to the plane 60 is dimensioned to ensure that the material support surface 20 of the device 10 is coplanar with the plane 60 when the device 10 is supported on the device support surface 80. In some embodiments, the distance cannot be adjusted, and the apparatus is manufactured for use with material processing devices having a specific bottom surface to bed surface dimension.

In other embodiments, such as, for example, the illustrated embodiment, the distance can be adjusted, and therefore the apparatus can be used with a plurality of material processing devices, each having a different bottom surface to bed surface dimension, such as material processing devices from different manufacturers. While any suitable system can be employed to enable the adjustment, in this embodiment the distance can be adjusted inasmuch as the position of the device support surface 80 can be adjusted relative to the first and second support surfaces 50A,50B. It should be understood that in other embodiments, the positions of the first and second support surfaces 50A,50B can additionally or alternately be adjusted relative to the device support surface 80.

With regard to the adjustability in the illustrated embodiment, the device support surface 80 is adjustable below the plane 60. More specifically, the device support member 130 can engage the first and second support members 120A,120B so that the device support surface 80 can be selectively placed at each of a plurality of locations relative to the plane 60.

The engagement is enabled by at least one groove on each vertical support member 120A,120B, and at least one corresponding tongue 150A,150B on the device support member 130, that engages the groove. The tongue 150A,150B can fit within the groove so that when the weight of the material processing device 10 presses downwardly on the device support surface 80, the bottom surface of the tongue 150A,150B is supported by the bottom surface of the groove.

In the illustrated embodiment, a plurality of groove sets 140A1-140B1,140A2-140B2,140A3-140B3,140A4-140B4 are provided for macro adjustment of the distance from the device support surface 80 to the plane 60. More specifically, for example, the groove sets are vertically spaced one inch apart. The device support member 130 can be moved by sliding the tongues 150A,150B out of one groove set (e.g., 140A1-140B1) and sliding them into another groove set (e.g., 140A3-140B3). This moves the device support member 130 relative to the vertical support members 120A,120B. Because the device support surface 80 is provided by the device support member 130, moving the device support member 130 from one groove set to another moves the device support surface 80 relative to the grooved surface and the plane 60. In this example, because the groove sets are vertically spaced one inch apart, the device support surface 80 is raised by two inches. This is useful, for example, if the apparatus is first used to support a first material processing device, and then must be used to support a second material processing device, and the first device has a bottom surface to bed surface dimension that is two inches deeper than that of the second device.

Further in the illustrated embodiment, each tongue 150A,150B is formed on a side of the device support member 130 so as to provide for micro adjustment of the distance from the device support surface 80 to the plane 60. More specifically, the device support member 130 has a top surface 160, and a bottom surface 170, each of which can serve as the device support surface 80 depending on the manner in which the device support member 130 is disposed in the apparatus. The various ways in which the device support member 130 can be disposed in the apparatus provide the micro adjustment and are discussed below. Generally, the macro adjustments are provided by moving the tongues 150A,150B from one groove set 140A1-140B1,140A2-140B2,140A3-140B3,140A4-140B4 to another, while the micro adjustments are provided by changing the device support member's 130 orientation (e.g., by flipping and/or rotating) in the apparatus, as described below.

Each tongue 150A,150B protrudes from a respective side 180A,180B of the device support member 130. Each tongue 150A,150B is thinner than the side 180A,180B from which it protrudes. Further, each tongue 150A,150B is not centrally disposed on the side 180A,180B from which it protrudes, such that the offset distance from the tongue 150A,150B to the top surface 160 of the device support member 130 and the offset distance from the tongue 150A,150B to the bottom surface 170 of the device support member 130 are not of equal length. Accordingly, when the device support member 130 is disposed with the tongues 150A,150B in a groove set with the top surface 160 serving as the device support surface 80, the distance from the device support surface 80 to the plane 60 is not equal to the distance from the device support surface 80 to the plane 60 when the device support member 130 is disposed with the tongues 150A,150B in the same groove set but with the bottom surface 170 serving as the device support surface 80 (e.g., flipped over). Therefore, for each macro setting, two micro settings are provided by the configuration of the tongues 150A,150B.

Importantly, due to the manner in which the tongues 150A,150B are formed on the sides 180A,180B (i.e., with the offset distances being unequal), only one groove is needed to provide multiple (in this example 2) micro adjustment settings.

Additional degrees of micro adjustment can be provided. In the illustrated embodiment, additional degrees are provided inasmuch as the device support member 130 can be reoriented in the apparatus in other ways. The reorientation in this embodiment includes not only flipping the device support member 130 as described above, but also rotating the device support member 130. More specifically, the device support member 130 can be removed by extracting the tongues from the groove set with which they are engaged, then flipped and/or rotated to effect the desired orientation, then replaced. The device support member 130 is square and additional tongues 150C,150D protrude from the other parallel sides 180C,180D of the device support member 130. As with the tongues 150A,150B discussed above, each tongue 150C,150D is thinner than the side 180C,180D from which it protrudes. Further, each tongue 150C,150D is not centrally disposed on the side 180C,180D from which it protrudes, such that the offset distance from the tongue 150C,150D to the top surface 160 of the device support member 130 and the offset distance from the tongue 150C,150D to the bottom surface 170 of the device support member 130 are not of equal length. To provide micro adjustment degrees additional to those provided by the tongues 150A,150B discussed above, the tongues 150C,150D have a different thickness than the tongues 150A,150B discussed above, and/or are disposed at a different position on their sides 180C,180D than the position of the tongues 150A,150B on their sides 180A,180B. Therefore, for each macro setting, two additional micro settings are provided by the additional tongues 180C,180D and the configuration of the additional tongues 180C,180D.

Importantly, because of the provision of additional tongues 150C,150D on the other parallel sides 180C,180D, and due to the manner in which the tongues 150A,150B,150C,150D are formed on the sides 180A,180B,180C,180D, only one groove is needed to provide an even greater number (in this example 4) of micro adjustment settings. More specifically, each tongue 150A,150B,150C, 150D has associated therewith first and second offset distances, the distances being unequal. The first offset distance, noted above, is the distance from the tongue to the top surface 160 of the device support member 130. The second offset distance, noted above, is the distance from the tongue to the bottom surface 170 of the device support member 130. Cooperating tongues, i.e., the tongues on parallel sides (e.g., tongues 150A and 105B are cooperating tongues in this embodiment) have the same thickness, the same first offset distance, and the same second offset distance.

Accordingly, there are two important sums associated with each set of cooperating tongues, that establish the distance from the device support surface 80 to the plane 60 in any given orientation of the device support member 130. The first sum is the sum of the tongue thickness and the first offset distance. The second sum is the sum of the tongue thickness and the second offset distance. For each tongue set, the first sum should not be equal to the second sum (otherwise, flipping the device support member 130 would not change the distance from the device support surface 80 to the plane 60). Furthermore, for the provision of additional tongue sets to add additional micro adjustment settings, neither the first sum nor the second sum of any tongue set should be equal to the first sum or the second sum of any other tongue set (otherwise, rotating and/or flipping the device support member would not change the distance from the device support surface 80 to the plane 60).

It will be evident to those skilled in the art that while the device support member 130 in the illustrated embodiment is square, the shapes of the device support members in other embodiments can be other equilateral polygons, and the number of sides of the polygon is a multiple of four. The additional parallel sides could support additional cooperating tongues of varying formations, and therefore could provide a greater number of micro adjustment settings, both by way of flipping and/or rotating. For example, in the illustrated embodiment, four micro adjustment settings are provided by the two cooperating tongue sets. In an embodiment where the device support member is an eight-sided equilateral polygon, eight micro adjustment settings can be provided. In an embodiment where the device support member is a twelve-sided equilateral polygon, twelve micro adjustment settings can be provided, and so forth.

It should also be evident that while the device support surface 80 in the illustrated embodiment is flat, the device support surface in other embodiments can be slanted, curved and/or otherwise uneven and/or adjustable with regard to the curvature, slant, or unevenness, to accommodate a variety of material processing devices that have bottom surfaces that are not flat.

The construction of the device support member 130 in the illustrated embodiment will now be described in greater detail to more clearly set forth how the micro adjustment is achieved in this embodiment. As shown in FIG. 4, the device support member 130 is 1 inch thick, and the tongues 150A,150B are ½ inch thick and disposed on the sides 180A,180B so that the offset distance from the top surface is ½ inch and the offset distance from the bottom surface is 0 inches thick. Grooves 140A1 and 140B1 are ½ inch thick, and their bottom surfaces and are located 5 inches below the plane 60. Grooves 140A3 and 140B3 are also ½ inch thick, and their bottom surfaces and are located 3 inches below the plane 60. Therefore, when the device support member 130 is disposed with the tongues 150A,150B in the grooves 140A1 and 140B1 with the top surface 160 serving as the device support surface 80, the device support surface 80 is (5 inches [the distance from the plane 60 to the bottom surfaces of the grooves 140A1 and 140B1] minus ½ inch [the thickness of the tongue 150A,150B] minus ½ inch [the offset distance from the tongue 150A,150B to the top surface 160]=) 4 inches from the plane 60.

But when the device support member 130 is then removed, flipped, and replaced in the same grooves 140A1 and 140A1 so it is disposed with the tongues 150A,150B in the grooves 140A1 and 140A1 with the bottom surface 170 serving as the device support surface 80, the device support surface 80 is (5 inches [the distance from the plane 60 to the bottom surfaces of the grooves 140A1 and 140B1] minus ½ inch [the thickness of the tongue 150A,150B] minus 0 inches [the offset distance from the tongue 150A,150B to the bottom surface 170]=) 4½ inches from the plane 60.

Similarly, when the device support member 130 is disposed with the tongues 150A,150B in the grooves 140A3 and 140B3 with the top surface 160 serving as the device support surface 80, the device support surface 80 is (3 inches [the distance from the plane 60 to the bottom surfaces of the grooves 140A3 and 140B3] minus ½ inch [the thickness of the tongue 150A,150B] minus ½ inch [the offset distance from the tongue 150A,150B to the top surface 160]=) 2 inches from the plane 60. But when the device support member 130 is then removed, flipped, and replaced in the same grooves 140A3 and 140B3 so it is disposed with the tongues 150A,150B in the grooves 140A3 and 140B3 with the bottom surface 170 serving as the device support surface 80, the device support surface 80 is (3 inches [the distance from the plane 60 to the bottom surfaces of the grooves 140A3 and 140B3] minus ½ inch [the thickness of the tongue 150A,150B] minus 0 inches [the offset distance from the tongue 150A,150B to the bottom surface 170]=) 2½ inches from the plane 60.

The tongues 150A,150B engage the other grooves 140A2,140B2 (having bottom surfaces located 4 inches below the plane 60) and 140A4,140A4 (having bottom surfaces located 2 inches below the plane 60) to provide additional locations of the device support surface 80 at (4″−½″−½″)=3″, (4″−½″−0″)=3½″, (2″−½″−½″)=1″, (2″−½″−0″)=1½″, respectively, from the plane 60.

Accordingly, two micro adjustment settings are provided for each macro setting.

The provision of additional micro adjustment settings in the illustrated embodiment will now be described in greater detail. As noted above, the device support member 130 is one inch thick. The additional tongues 150C,150D are ⅜ inch thick and disposed on the sides 180C,180D so that the offset distance from the top surface 160 of the device support member 130 is ⅜ inch and the offset distance from the bottom surface 170 is ¼ inch. Therefore, when the device support member 130 is disposed with the tongues 150C,150D in the grooves 140A1 and 140B1 with the top surface 160 serving as the device support surface 80, the device support surface 80 is (5 inches [the distance from the plane 60 to the bottom surfaces of the grooves 140A1 and 140B1] minus ⅜ inch [the thickness of the tongue 150C,150D] minus ¼ inch [the offset distance from the tongue 150C,150D to the top surface 160]=) 4⅜ inches from the plane 60.

But when the device support member 130 is then removed, flipped, and replaced in the same grooves 140A1 and 140B1 so it is disposed with the tongues 150C,150D in the grooves 140A1 and 140B1 with the bottom surface 170 serving as the device support surface 80, the device support surface 80 is (5 inches [the distance from the plane 60 to the bottom surfaces of the grooves 140A1 and 140B1] minus ⅜ inch [the thickness of the tongue 150A,150B] minus ⅜ inch [the offset distance from the tongue 150C,150D to the bottom surface 170]=) 4¼ inches from the plane 60.

Similarly, when the device support member 130 is disposed with the tongues 150C,150D in the grooves 140A3 and 140B3 with the top surface 160 serving as the device support surface 80, the device support surface 80 is (3 inches [the distance from the plane 60 to the bottom surfaces of the grooves 140A3 and 140B3] minus ⅜ inch [the thickness of the tongue 150C,150D] minus ¼ inch [the offset distance from the tongue 150C,150D to the top surface 160]=) 2⅜ inches from the plane 60. But when the device support member 130 is then removed, flipped, and replaced in the same grooves 140A3 and 140B3 so it is disposed with the tongues 150C,150D in the grooves 140A3 and 140B3 with the bottom surface 170 serving as the device support surface 80, the device support surface 80 is (3 inches [the distance from the plane 60 to the bottom surfaces of the grooves 140A3 and 140B3] minus ⅜ inch [the thickness of the tongue 150C,150D] minus ⅜ inch [the offset distance from the tongue 150C,150D to the bottom surface 170]=) 2¼ inches from the plane 60.

The tongues 150C,150D engage the other grooves 140A2,140B2 (having bottom surfaces located 4 inches below the plane 60) and 140A4,140A4 (having bottom surfaces located 2 inches below the plane 60) to provide additional locations of the device support surface 80 (4″−⅜″−¼″)=3⅜″, (4″−⅜″−⅜″)=3¼″, (2″−⅜″−¼″)=1⅜″, (2″−⅜″−⅜″)=1¼″, respectively, from the plane 60.

Accordingly, two additional micro settings are provided for each macro adjustment setting.

Therefore, when any set of cooperating tongues is disposed in any set of cooperating grooves, the device support member 130 can be first removed, then flipped and/or rotated, then replaced in the same or another set of grooves, to selectively set the device support surface at the following distances from the plane 60: 1″, 1¼″, 1½″, 1⅜″, 2″, 2¼″, 2½″, 2⅜″, 3″, 3¼″, 3½″, 3⅜″, 4″, 4¼″, 4½″, 4⅜″.

A particular example of the use of the illustrated embodiment of the apparatus will now be described. A construction worker desires to process a first long beam of wood at a first construction site and a second long beam of wood at a second construction site.

The first construction site has several saw horses of varying height, six saw horses being 4 feet high, and 3 saw horses being 3½ feet high. Two power tools are at the first construction site: a first chop saw and a first table saw. The first chop saw has a bottom surface to bed surface dimension of 4 inches. The first table saw has a bottom surface to bed surface dimension of 3¼ inches.

The second construction site has several other saw horses of varying height, three saw horses being 3 feet high and eight saw horses being 5 feet high. Two other power tools are at the second construction site: a second chop saw and a second table saw. The second chop saw has a bottom surface to bed surface dimension of 4½ inches. The second table saw has a bottom surface to bed surface dimension of 2⅜ inches.

The construction worker brings the apparatus to the first construction site, sets up two of the six 4-foot saw horses next to one another, and hangs the apparatus between them, with the downwardly facing contact surfaces 122A,122B resting on the first and second support surfaces 50A,50B provided by the saw horses. The construction worker then determines and effects the orientation of the device support member 130 that will set the distance between the device support surface 80 and the plane 60 to be 4 inches, so that the first chop saw can be used.

More specifically, the construction worker removes the device support member 130 (if necessary), and orients the device support member 130 so that when the device support member 130 is replaced, the tongues 150A,150B will engage the grooves 140A1,140B1 with the top surface 160 of the device support member 130 serving as the device support surface 80. Once the device support member 130 is in place, the construction worker places the first chop saw on the processor support surface 80, the target portion of the first beam on the bed surface of the first chop saw, and the remaining four 4-foot saw horses under the extensions of the first beam to support them. The construction worker then operates the first chop saw to process the first beam as desired.

In order to process the first beam using the first table saw, the construction worker removes the beam and the first chop saw. The construction worker then determines and effects the orientation of the device support member 130 that will set the distance between the processor support surface 80 and the plane 60 to be 3¼ inches, so that the first table saw can be used. More specifically, the construction worker removes the device support member 130, and orients the device support member 130 so that when the device support member 130 is replaced, the tongues 150C,150D will engage the grooves 140A2,140B2 with the bottom surface 170 of the device support member 130 serving as the device support surface 80. Once the device support member 130 is in place again, the construction worker places the first table saw on the processor support surface 80, the target portion of the first beam on the bed surface of the first table saw, and the extensions of the first beam on the four 4-foot saw horses. The construction worker then operates the first table saw to process the first beam as desired.

When finished with the material processing of the first beam, the construction worker removes the beam and the first table saw, and loads the apparatus into a truck for transportation to the second construction site. There, the construction worker sets up two of the eight 5-foot saw horses next to one another, and hangs the apparatus between them, with the downwardly facing contact surfaces 122A,122B resting on the first and second support surfaces 50A,50B provided by the saw horses. The construction worker then determines and effects the orientation of the device support member 130 that will set the distance between the device support surface 80 and the plane 60 to be 4½ inches, so that the second chop saw can be used.

More specifically, the construction worker removes the device support member 130, and orients the device support member 130 so that when the device support member 130 is replaced, the tongues 150A,150B will engage the grooves 140A1,140B1 with the bottom surface 170 of the device support member 130 serving as the device support surface 80. Once the device support member 130 is in place, the construction worker places the second chop saw on the processor support surface 80, the target portion of the second beam on the bed surface of the second chop saw, and four of the other 5-foot saw horses under the extensions of the second beam to support them. The construction worker then operates the second chop saw to process the second beam as desired.

In order to process the second beam using the second table saw, the construction worker removes the beam and the second chop saw. The construction worker then determines and effects the orientation of the device support member 130 that will set the distance between the processor support surface 80 and the plane 60 to be 2⅜ inches, so that the second table saw can be used. More specifically, the construction worker removes the device support member 130, and orients the device support member 130 so that when the device support member 130 is replaced, the tongues 150C,150D will engage the grooves 140A3,140B3 with the top surface 160 of the device support member 130 serving as the device support surface 80. Once the device support member 130 is in place again, the construction worker places the second table saw on the processor support surface 80, the target portion of the second beam on the bed surface of the second table saw, and the extensions of the second beam on the four 5-foot saw horses. The construction worker then operates the second table saw to process the second beam as desired. When the material processing of the second beam is complete, the beam can be removed, the second table saw can be removed, and the apparatus can be transported to another site.

It should be evident that the apparatus of the invention has several advantages. First, it can support a plurality of power tools, each having a different bottom surface to bed surface dimension. In the illustrated embodiment, for each of the four macro settings, there are four micro settings, providing a total of sixteen settings, specified above. In other embodiments, an even greater number of settings, in smaller or larger increments, can be achieved by varying the number of grooves, the thickness of the grooves, the number of cooperating tongue sets (in conjunction with increasing the number of parallel sides of the device support member), the thickness of the tongues, and the disposition of the tongues relative to the sides of the device support member (i.e., altering the offset distances).

Second, the adjustment is effected with a reduced number of moving and mechanically cooperating parts, and a reduced complexity of the cooperation. In other apparatuses, the adjustment is effected by cooperating toothed gear assemblies, compression locking assemblies, and the like. Here, the adjustment is effected by engaging grooves with tongues, which is far less demanding on the interacting components. This increases the durability and reliability of the adjustment mechanism.

Third, the apparatus does not rely for its use on support structures of a particular height, or that have a particular height-adjustability range. The apparatus can be used with any two support structures having the same height, whether or not the height is adjustable, and whether or not the support structures are of the same type. This is subject, of course, to the limitation that the support surfaces must be high enough so that the bottom of the apparatus is off the ground (or other platform) when secured to the support structures. Typically, at least two saw horses of the same height are present at any given construction site, and therefore, these saw horses can be used conveniently without having to transport saw horses of a certain height to the construction site.

Fourth, the apparatus can be used to support very long extensions of the workpiece, since, if additional support structures are available that have the same height as the support structures supporting the apparatus, they can be used to provide extension support surfaces. Typically, several saw horses of the same height will be available at any given construction site, and therefore two can be used to support the apparatus and additional ones can be used to support extensions of the workpiece.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. An apparatus for suspending a material processing device between first and second support structures respectively having first and second support surfaces arranged within a plane and defining a space therebetween across which a material to be operated on by the device is supportable on the first and second support surfaces, the material processing device having a material support surface, comprising:
a device support surface upon which the material processing device is supportable with the material support surface in the plane; and
at least one support member securing the device support surface to the first and second support structures so that the device support surface is suspended within the space and below the plane.

2. The apparatus of claim 1, wherein the support member comprises first and second support members, the first support member having a contact surface that can rest in the plane on the first support surface and the second support member having a contact surface that can rest in the plane on the second support surface.

3 The apparatus of claim 1, wherein the device support surface is adjustable below the plane.

4. The apparatus of claim 3, wherein the support member comprises a groove and the device support surface is provided by a device support member having a tongue that can engage the groove to secure the device support member to the support member.

5. The apparatus of claim 4, wherein the tongue is operable to engage the groove to secure the device support member in each of a plurality of alternate orientations in which the device support member can be secured by engagement of the groove by the tongue, wherein each orientation locates the device support surface at a respective one of a plurality of alternate locations.

6. The apparatus of claim 5, wherein the device support member has at least one other tongue operable to engage the groove to secure the device support member in each of a plurality of additional alternate orientations in which the device support member can be secured by engagement of the groove by the other tongue, wherein each additional alternate orientation locates the device support surface at a respective one of a plurality of additional alternate locations.

7. The apparatus of claim 5, wherein the device support member has top and bottom surfaces, and a side separating the top and bottom surfaces and from which the tongue protrudes, the side being thicker than the tongue.

8. The apparatus of claim 7, wherein an offset distance from the tongue to the top surface and an offset distance from the tongue to the bottom surface are not equal.

9. The apparatus of claim 7, wherein the groove has a bottom surface and the tongue has top and bottom surfaces, and when the tongue engages the groove such that the bottom surface of the tongue is in contact with the bottom surface of the groove, the top surface of the device support member serves as the device support surface and the device support surface is at a first distance from the plane, and when the tongue engages the groove such that the top surface of the tongue is in contact with the bottom surface of the groove, the bottom surface of the device support member serves as the device support surface and the device support surface is at a second distance from the plane, the first and second distances being of different lengths.

10. An apparatus for locating a surface at each of a plurality of alternate locations relative to a reference plane, comprising:
a member having a surface and having a tongue operable to engage a groove to secure the member in each of a plurality of alternate orientations in which the member can be secured by engagement of the groove by the tongue, wherein each orientation locates the surface at a respective one of the alternate locations.

11. The apparatus of claim 10, wherein the member has top and bottom surfaces and a side from which the tongue protrudes, the side being thicker than the tongue.

12. The apparatus of claim 11, wherein an offset distance from the tongue to the top surface and an offset distance from the tongue to the bottom surface are not equal.

13. The apparatus of claim 11, wherein the member has at least one other tongue operable to engage the groove to secure the member in each of a plurality of additional alternate orientations in which the member can be secured by engagement of the groove by the other tongue, wherein each additional alternate orientation locates the surface at a respective one of a plurality of additional alternate locations.

14. The apparatus of claim 11, wherein the groove has a bottom surface and the tongue has top and bottom surfaces, and when the tongue engages the groove such that the bottom surface of the tongue is in contact with the bottom surface of the groove, the top surface of the member serves as the surface and the surface is at a first distance from the plane, and when the tongue engages the groove such that the top surface of the tongue is in contact with the bottom surface of the groove, the bottom surface of the member serves as the surface and the surface is at a second distance from the plane, the first and second distances being of different lengths.

15. A planar substrate comprising:
top and bottom surfaces;
two parallel sides separating the top and bottom surfaces; and
two parallel guide members, one extending along each side, each guide member being thinner than the sides; wherein
an offset distance from the top surface to either guide member and an offset distance from the bottom surface to either guide member are not equal.

16. A planar substrate comprising:
top and bottom surfaces, each shaped as an equilateral polygon with its number of sides being a multiple of four;
at least two sets, each set comprising two parallel sides separating the top and bottom substrate surfaces, each set further comprising two parallel guide members, one guide member extending along each side, each guide member having top and bottom surfaces respectively coplanar with the top and bottom surfaces of the other guide; wherein
each set has associated therewith two distances, one being a distance from either top guide surface to the bottom substrate surface, the other being a distance from either bottom guide surface to the top substrate surface; and wherein
none of the distances in any of the sets is equal to another distance in any of the sets.
